(19) United States
(12) Patent Application Publication
(10) Pub. No.: US 2019/0184464 A1
(43) Pub. Date: Jun. 20, 2019

(54) 3D Printing Method of a Metal Object

(71) Applicant: METAL INDUSTRIES RESEARCH & DEVELOPMENT CENTRE, Kaohsiung City (TW)

(72) Inventors: Yue-Jun Wang, Kaohsiung City (TW); Chun-Chieh Tseng, Kaohsiung City (TW); Li-Wen Weng, Kaohsiung City (TW); Tung-Lin Tsai, Kaohsiung City (TW); Ying-Cheng Lu, Kaohsiung City (TW); Chiu-Feng Lin, Kaohsiung City (TW)

(21) Appl. No.: 15/844,701

(22) Filed: Dec. 18, 2017

(51) Int. Cl. B22F 3/15; B22F 3/16; B22F 3/10

(52) U.S. Cl. CPC B22F 3/15; B33Y 10/00; B22F 3/1007; B22F 3/16

(57) ABSTRACT

A 3D printing method of a metal object includes stacking molten metal powders along an outlined path to form a metal object. An inert gas is introduced into a chamber with the metal object inside, and the metal object is hot isostatic pressed in the chamber at 80-120 MPa and 900-1000° C. for 1-4 hours.

### BACKGROUND OF THE INVENTION

### 1. Field of the Invention

The present invention generally relates to a 3D printing method and, more particularly, to a 3D printing method of a metal object.

### 2. Description of the Related Art

3D printing, also known as additive manufacturing (AM), refers to a process used to form an object by stacking a molten material (such as molten metal powders), which is molten by a laser beam or an electron beam, along an outlined path under computer control. 3D printing is a high precision process, and thus is able to form parts for industries such as aerospace, medical and automotive industries.

However, the metal powders also forms vapor at temperature near its boiling point by the laser beam. The formed vapor blows out some of unmolten metal powders, and thus a plurality of pores formed in the metal object as shown in FIG. 1. Therefore, the metal object has poor mechanical properties and the conventional 3D printing method of the metal object should be improved.

### SUMMARY OF THE INVENTION

It is therefore an objective of the present invention to provide a 3D printing method of a metal object to obtain the metal object with decreased porosity.

One embodiment of the invention discloses the 3D printing method of the metal object. The method includes stacking molten metal powders along an outlined path to form a metal object. An inert gas is introduced into a chamber with the metal object inside. The metal object in the chamber is then hot isostatic pressed at 80-120 MPa and 900-1000° C. for 1-4 hours. The inert gas is selected from nitrogen gas, argon gas or helium gas. Accordingly, by the hot isostatic pressing process, compared to the metal object, the obtained processed metal object has decreased porosity as well as changed metallographic phase, and thus, the mechanical properties of the metal object are also improved.

In an example, nitrogen gas is introduced into the chamber, and the metal object in the chamber is hot isostatic pressed at 120 MPa and 1000° C. for 2 hours. Thus, the porosity of the metal object can be effectively decreased.

In an example, the molten metal powders is repeatedly stacked along the outlined path a plurality of times to form the metal object. As an example, the molten metal powders is repeatedly stacked along the outlined path 3-5 times to form the metal object. Thus, pores inside the metal object can be effectively isolated from outside environment, improving the effect of the hot isostatic pressing process.

### BRIEF DESCRIPTION OF THE DRAWINGS

FIG. 1 depicts a metallographic graph of a conventional metal object formed by a conventional 3D printing method.

FIG. 2 depicts a metallographic graph of a metal object formed by the 3D printing method according to an embodiment of the present invention.

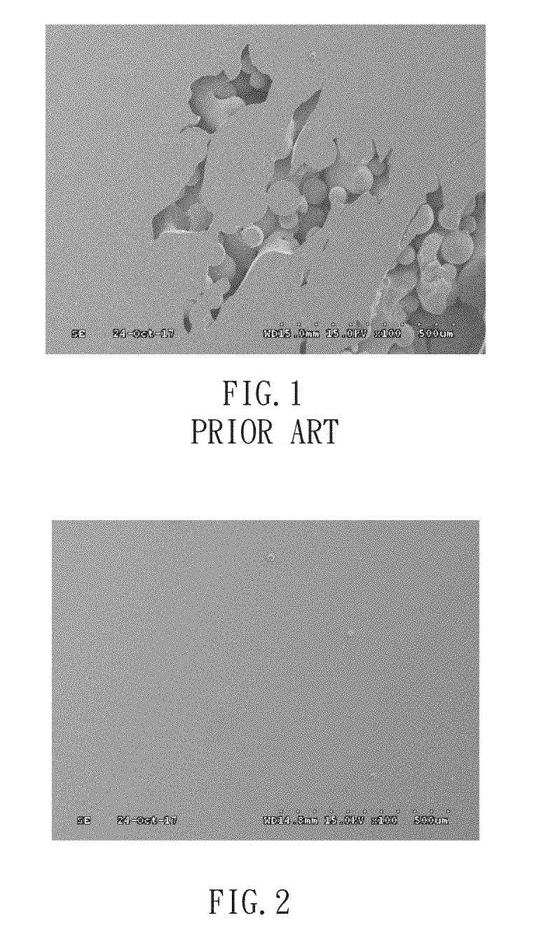

### DETAILED DESCRIPTION OF THE INVENTION

A 3D printing method of a metal object according to an embodiment of the present invention includes a 3D printing process and a hot isostatic pressing process. Porosity of the metal object formed in the 3D printing process can be decreased by the hot isostatic pressing process.

Specifically, in the 3D printing process, a worker can melt metal powders (for example, stainless steel powders or titanium alloy powder by a laser beam or an electronic beam to form molten metal powders. The molten metal powders is then stacked along an outlined path under computer control to form the metal object. Moreover, the worker can process the 3D printing process by any conventional 3D printer, which can be appreciated by a person having ordinary skill in the art. Detail description is not given to avoid redundancy.

It is worthy to note that to improve efficiency of the hot isostatic pressing process, the worker can repeatedly stack the molten metal powders along the outlined path several times to form the metal object, assuring pores inside the metal object can be effectively isolated from outside environment. As an example, for the stainless steel powders with a lower boiling point, the molten stainless steel powders can be repeatedly stacked 3 times. For the titanium alloy powders with a higher boiling point, the molten titanium alloy powders can be repeatedly stacked 5 times.

Then, in the hot isostatic pressing process, the worker can place the metal object into a chamber such as a casserole made of ceramics. An inert gas is introduced into the chamber. The metal object inside the chamber can thus be hot isostatic pressed at 80-120 MPa and 900-1000° C. for 1-4 hours to form a processed metal object. With such treatment, the pores formed inside the metal object shrink or even disappear. Moreover, the processed metal object has metallographic phase different from metallographic phase of the metal object, and thus, compared to mechanical properties of the metal object, the processed metal object has improved mechanical properties. For example, the metallographic phase change from α phase to β phase, and the mechanical property such as yield strength is improved. In this embodiment, the inert gas is selected from nitrogen gas (N₂), argon gas (Ar) or helium gas (He).

Furthermore, after the hot isostatic pressing process, the worker can cool the processed metal object in the chamber. In this situation, the processed metal object is cooled in a cooling velocity of 1-10° C./minute. The worker can also remove the processed metal object out of the chamber, and the processed metal object can be cooled under room temperature with the cooling velocity of 5-50° C./minute. Moreover, the worker can remove the processed metal object out of the chamber and cool the processed metal object using a cooling gas such as argon gas or nitrogen gas at room temperature. In this situation, the processed metal object is cooled in the cooling velocity of 20-100° C./minute. Thus, a finished product can be obtained.

To evaluate compared to the metal object, the processed metal object has decreased porosity and improved mechanical properties, Taguchi experiment with several factors such as the inert gas used in the hot isostatic pressing process, pressure, temperature and time of the hot isostatic pressing process, and cooling velocity after the hot isostatic pressing process referring to TABLE 1 is carried out. The obtained finished product of groups A01-A18, soaked in an artificial body fluid at 37° C., is pre-pressed by 300 N, followed by being repeatedly pressed by 1800 N for 5 million times. Dynamic fatigue resistance is estimate by maximum loading time.

TABLE 1

| | | | | | | Max |
|---|---|---|---|---|---|---|
| | | Hot isostatic pressing | | | Cooling | loading |
| | | Pres- | Temper- | | velocity | time |
| | | sure | ature | Time | (° C./ | (×10⁶ |
| Group | Inert gas | (MPa) | (° C.) | (hour) | minute) | times) |
| A01 | Argon | 80 | 900 | 1 | 1-10 | 214 |
| A02 | Argon | 80 | 950 | 2 | 5-50 | 223 |
| A03 | Argon | 80 | 1000 | 4 | 20-200 | 341 |
| A04 | Argon | 100 | 900 | 1 | 5-50 | 334 |
| A05 | Argon | 100 | 950 | 2 | 20-200 | 376 |
| A06 | Argon | 100 | 1000 | 4 | 1-10 | 396 |
| A07 | Argon | 120 | 900 | 2 | 1-10 | 408 |
| A08 | Argon | 120 | 950 | 4 | 5-50 | 435 |
| A09 | Argon | 120 | 1000 | 1 | 20-200 | 433 |
| A10 | Nitrogen | 80 | 900 | 4 | 20-200 | 218 |
| A11 | Nitrogen | 80 | 950 | 1 | 1-10 | 218 |
| A12 | Nitrogen | 80 | 1000 | 2 | 5-50 | 345 |
| A13 | Nitrogen | 100 | 900 | 2 | 20-200 | 356 |
| A14 | Nitrogen | 100 | 950 | 4 | 1-10 | 376 |
| A15 | Nitrogen | 100 | 1000 | 1 | 5-50 | 383 |
| A16 | Nitrogen | 120 | 900 | 4 | 20-200 | 409 |
| A17 | Nitrogen | 120 | 950 | 1 | 20-200 | 423 |
| A18 | Nitrogen | 120 | 1000 | 2 | 1-10 | 451 |

Referring to TABLE 1, the finished product of group A18 shows the best dynamic fatigue resistance capacity, suggesting that when the inert gas is selected to be nitrogen gas, the hot isostatic pressing process is selected to be performed at 120 MPa and 1000° C. for 2 hours, and after the hot isostatic pressing process, the metal object is selected to be cooled at the cooling velocity of 1-10° C./minute in the chamber, the 3D printing method of the metal object according to this embodiment of the present invention shows a preferable effect. Moreover, referring to FIG. 2, the metallographic graph of the finished product of group A18 suggests that the porosity of the processed metal object indeed decreases or even disappears.

In conclusion, by the hot isostatic pressing process, compared to the metal object, the obtained processed metal object has decreased porosity as well as changed metallographic phase, and thus, the mechanical properties of the metal object are also improved.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A 3D printing method of a metal object, comprising:
stacking molten metal powders along an outlined path to form a metal object;
introducing an inert gas into a chamber with the metal object inside; and
hot isostatic pressing the metal object inside the chamber at 80-120 MPa and 900-1000° C. for 1-4 hours.

2. The 3D printing method of the metal object as claimed in claim 1, wherein the insert gas introduced into the chamber is selected from nitrogen gas, argon gas or helium gas.

3. The 3D printing method of the metal object as claimed in claim 1, wherein nitrogen gas is introduced into the chamber and the metal object is hot isostatic pressed at 120 MPa, 1000° C. for 2 hours.

4. The 3D printing method of the metal object as claimed in claim 1, wherein the molten metal powders is repeatedly stacked along the outlined path a plurality of times to form the metal object.

5. The 3D printing method of the metal object as claimed in claim 4, wherein the molten metal powders is repeatedly stacked along the outlined path 3-5 times to form the metal object.
